(19) United States
(12) Patent Application Publication
(10) Pub. No.: US 2021/0036777 A1
(43) Pub. Date: Feb. 4, 2021

(54) OPTICAL COMMUNICATION NETWORK FOR PICO SATELLITES

(71) Applicant: ARIEL SCIENTIFIC INNOVATIONS LTD., Ariel (IL)

(72) Inventors: Boaz BEN MOSHE, Herzliya (IL); Nir SHVALB, Kibutz Bahan (IL)

(21) Appl. No.: 17/046,231

(22) PCT Filed: Apr. 8, 2019
(86) PCT No.: PCT/IL2019/050398

§ 371 Date: Oct. 8, 2020

Related U.S. Application Data
(60) Provisional application No. 62/654,472, filed on Apr. 8, 2018.

(51) Int. Cl. H04B 10/112; H04B 10/118; G01S 3/786; H04B 10/50

(52) U.S. Cl. CPC H04B 10/112; H04B 10/503; G01S 3/7867; H04B 10/118

(57) ABSTRACT

A digital communication system comprising: an optical receiver comprising a detector configured to receive a laser optical signal from an optical transmitter; a curved mirror; an optical detector associated with said curved mirror; and an automated tracking system configured to: (i) determine a desired orientation of said optical receiver in relation to said optical transmitter, based, at least in part, on detecting a celestial location of said optical transmitter, (ii) move said optical receiver to said orientation, and (iii) continuously adjust said orientation to maximize a measured strength of said received optical signal.

### CROSS-REFERENCE TO RELATED APPLICATIONS

This application claims the benefit of priority to U.S. Provisional Patent Application No. 62/654,472, filed Apr. 8, 2018, entitled “OPTICAL COMMUNICATION NETWORK FOR PICO SATELLITES,” the contents of which are incorporated herein by reference in their entirety.

### BACKGROUND

The invention relates to the field of optical communication systems.

Traditionally, space industry designs include massive, cutting-edge satellites, both for communication and military applications. Vast resources have been invested in satellites, often led by governmental agencies such as NASA, ESA, etc.

Newer space technologies, on the other hand, are mostly led by private companies, that may be influenced by civilian trends, such as smartphones, internet of things (IoT), cloud-based techniques, and/or the like. For example, the use of hundreds of Low Earth Orbit (LEO) nanosatellites for achieving global communication and/or connectivity. For example, free space optical (FSO) communication between nanosatellites and earth based robotic telescopes may be used for communications.

Free-space optical communication (FSO) is an optical communication technology that uses light propagating in free space to wirelessly transmit data for telecommunications or computer networking. The technology is useful where the physical connections between communication devices are impractical due to high costs or other considerations. FSO may allow a significant wider bandwidth without radiofrequency (RF) regulation and may be applicable for small form-factor satellites. For example, fast, full duplex earth to satellite communications without RF regulation or RF-charging costs. A global network of small-size LEO satellites may connect points on earth (or near earth—e.g., airplanes) to realize a low-cost, high-speed, communications network.

FSO communication systems are an alternative solution to optical fibered communication systems as they are easier to install (and uninstall), cheaper, secure, and need no frequency regulation. However, the range of FSO systems is limited by atmospheric properties, such as transparency, turbulence, and/or the like.

Following are some FSO communication technologies in use. Lightpointe™ Communication Ltd. manufactures point-to-point gigabit ethernet FSO systems and hybrid optical-radio bridges. Koruza™ has developed as an open source project in cooperation with the Institute for Development of Advanced Applied Systems (IRNAS) and a company named Fabrikor™. The Koruza system is about the size of a security camera and includes two sub-systems: a tuning sub-system and a communication sub-system. The tuning sub-system includes three motors and a motor controller. Two motors are used for the x-y movement and a third motor to adjust the lens' focus. The communication sub-system includes of a media converter, a Small Form-factor Pluggable (SFP) electro-optical transceiver and a lens. The signal is transferred from a ethernet port to the media converter that converts, using the transceiver, the ethernet signal into an optical signal, and sends the optical signal through the lens to the other transceiver (receiving end). On the receiving side, the light is focusing through the lens and enters the SFP receiver, into the media converter that converts the detected light into an electrical signal.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope

There is provided, in an embodiment, a device for free space optical communication, comprising: an optical receiver comprising a detector configured to receive a laser optical signal from an optical transmitter; a curved mirror; and an optical detector associated with said curved mirror.

There is also provided, in an embodiment, a digital communication system comprising: an optical receiver comprising a detector configured to receive a laser optical signal from an optical transmitter; a curved mirror; an optical detector associated with said curved mirror; and an automated tracking system configured to: (i) determine a desired orientation of said optical receiver in relation to said optical transmitter, (ii) move said optical receiver to said orientation, and (iii) continuously adjust said orientation to maximize a measured strength of said received optical signal.

There is further provided, in an embodiment, a method for free space optical communication, comprising operating at least one hardware processor for: determining a desired orientation of an optical receiver in relation to an optical transmitter, wherein said optical receiver comprises a curved mirror and an optical detector associated with said curved mirror, moving said optical receiver to said orientation, and adjusting continuously said orientation to maximize a measured strength of said received optical signal.

In some embodiments, said determining is based, at least in part on one of: detecting a celestial location of said optical transmitter, and performing a scan by said optical receiver to detect a signal of the said optical transmitter.

In some embodiments, said detecting is based, at least in part, on a known position of said optical transmitter in relation to one or more identified celestial objects.

In some embodiments, said curved mirror has a curve shape selected from the group consisting of: spherical, parabolic, and toroidal.

In some embodiments, said curved mirror is a concave mirror configured to reflect at least some of said optical signal from a surface of said concave mirror to a focal point of said concave mirror.

In some embodiments, said detector is located at one of: a focal point of said curved mirror and a center of curvature of said curved mirror.

In some embodiments, the optical receiver comprises at least one micro-electro-mechanical system (MEMS) mirror.

In some embodiments, the optical transmitter is configured to transmit an optical signal of a specific wavelength and wherein the optical receiver is configured to receive the optical signal.

In some embodiments, the specific wavelength is between 100 nanometers (nm) and 4 micrometers (μm). in some embodiments, the specific wavelength is between 100 nm and 2700 nm. In some embodiments, the specific wavelength is between 1 μm and 4 μm.

There is further provided in an embodiment, a digital communication system comprising: an optical transmitter; an optical receiver comprising (i) a detector configured to receive an optical signal, and (ii) an infrared (IR) beacon configured to emit an IR signal towards the optical transmitter, wherein optical axes of the detector and the IR beacon are substantially parallel, wherein the optical transmitter comprises: (a) a laser configured to transmit the optical signal matched in frequency to the detector, (b) a sensor configured to receive an IR beacon signal from the IR beacon, (c) a controller configured to receive an output from the sensor, and (d) an electromechanical pointing device electrically connected to the controller, wherein the controller is further configured to adjust an orientation of the electromechanical pointing device based on the output from the sensor.

In some embodiments, the electromechanical pointing device comprises a two-axis gimbal.

In some embodiments, the electromechanical pointing device comprises at least one micro-electro-mechanical system (MEMS) mirror.

In some embodiments, the optical transmitter is configured to transmit an optical signal of a specific wavelength and wherein the optical receiver is configured to receive the optical signal.

In some embodiments, the specific wavelength is between 100 nanometers (nm) and 14 micrometers (μm). In some embodiments, the specific wavelength is between 100 nm and 2700 nm. In some embodiments, the specific wavelength is between 1 μm and 4 μm.

There is further provided in an embodiment, a method for free space optical communication, comprising: sending an IR beacon by an optical receiver; receiving the IR beacon by a sensor of an optical transmitter; adjusting, using at least one hardware processor of the optical transmitter, an electromechanical pointing device of the optical transmitter based on a signal from the sensor; transmitting an optical signal from the optical transmitter to the optical receiver; and receiving the optical signal at the optical receiver.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows a half-duplex subsystem for free space optical (FSO) communication according to an embodiment of the present invention;

FIG. 2 shows a half-duplex subsystem for free space optical (FSO) communication according to an embodiment of the present invention;

FIG. 3 shows a full-duplex system for FSO communication;

FIG. 4 shows a flowchart of a method for half-duplex FSO communication according to an embodiment of the present invention;

FIG. 5 shows a flowchart of a method for half-duplex FSO communication according to an embodiment of the present invention; and

FIG. 6 shows a graph of experimental results of FSO communication.

### DETAILED DESCRIPTION

Disclosed herein are methods, devices, systems, and sub-systems for free space optical (FSO) communications.

In some embodiments, a bi-directional, full duplex, communication system of the present disclosure uses two half-duplex sub-systems to create the full duplex communication link.

In some embodiments, each half-duplex sub-system comprises a receiver comprising a light detector placed at or about a focal point of a curved mirror configured to refocus optical signals received from a transmitter. In some embodiments, the curved mirror is a concave mirror. In some embodiments, the curved mirror has a curve shape that is one of spherical, parabolic, and toroidal.

In some embodiments, the receiver may comprise an automated tracking system configured to track a signal beam of the transmitter and to align the curved mirror dynamically for optimized reception of the laser signal.

In some embodiments, the curved mirror may be used to collect and refocus incoming optical rays, e.g., from a small source such as a laser signal, towards a focus and/or a focal point, for example, by directing rays to detector sensors at or about the focus. The curved mirror may include a main curved mirror, wherein a secondary lens with a sensitive receiver may be located at a focal of the curved mirror.

In some embodiments, using a curved mirror to collect and re-focus an optical signal may be cost efficient, for example, by reducing the need for a precise alignment of the receiver and transmitter, e.g., when using a telescope to receive and focus the optical signal. In some embodiments, the curved mirror's diameter may have an important influence on the system performance and operational range. A larger, e.g., main, curved mirror may collect more optical power to the detector and decrease the geometric attenuation.

In some embodiments, an initial receiving positioning and/or orientation of the receiver (e.g., a ground station) may be performed by first locating a position of the aerial station using, e.g., a Global Navigation Satellite System (GNSS) signal. In some embodiments, if the receiver is unable to locate a GNSS position, the receiver may be configured to perform a canning (e.g., an angular, matrix, and/or other scan) to locate the sender. Once the sender has been located, the receiver may, e.g., send a low bit-rate massage with the accurate timing, thus allowing an accurate aiming of the receiver based on the angular difference between the sender and the receiver.

In some embodiments, an initial receiving positioning and/or orientation of the receiver towards the transmitter may be achieved using a system which orients the receiver based on calculating a location of the transmitter in relation to identified celestial objects. Such as system may be based, e.g., on the system disclosed in U.S. Patent Publication Number 2019/0041217 to Ben Moshe et al., the contents of which are incorporated herein by reference in their entirety.

In some embodiments, once an initial positioning and/or orientation is achieved, the present system may continuously adjust a positioning and/or orientation of the receiver or portions thereof, based, e.g., of received signal strength. In some embodiments, an automated tracking system may include a tracking unit configured to continuously monitor an optical and/or other signal from the transmitter. In some embodiments, the tracking system then automatically determine an optimized position, orientation, and/or pose of the receiver, based on, e.g., a strength the received tracking signal. In some embodiments, the receiver or portions thereof may be located on a gimbal, e.g., a simple and/or mechanical gimbal, which may be guided by the tracking unit to align the receiver to the transmitter, by modifying, e.g., a position, an orientation, and/or a pose of the receiver or portions thereof.

In some embodiments, the automated tracking system may be configured to continuously monitor the optical signal from the transmitter, when a location, direction, source, and/or trajectory of the signal may change, e.g., periodically, in response to movement of the transmitter and/or atmospheric conditions. In some embodiments, based on the continuous detection of the optical signal, the automated tracking system may be configured to dynamically modify a position, orientation, and/or pose of the receiver, to ensure optimized reception.

In some embodiments of the present invention, for each sub-system, the receiver comprises an infrared (IR) beacon and signal detector with an optional lens. On the transmitter of the sub-system, there is a small camera that detects the beacon direction sent by the receiver and directs the orientation of a gimbal connected to the transmitter, thus keeping the laser transmitter aligned with the signal detector. A microprocessor closed loop with a gimbal lock algorithm allows automatically keeping the transmitter aligned with the receiver. The gimbal may be of a two-axis type for controlling pitch (lateral axis) and yaw (perpendicular axis). The roll movement (longitudinal axis) does not affect the link quality. The laser transmitter source is connected and calibrated to the gimbal such that when the small camera is aimed at the IR beacon, the laser transmitter source is facing directly towards the lens system of the receiver. The optional lens system focuses the laser signal on the detector sensors. For example, NASA's OPALS project (https://en.wikipedia.org/wiki/OPALS) using Scanning Mirrors may benefit from the aspects and/or embodiments that allow communication with several points in rapid succession (such as millisecond for each target) thus enabling a real-time relay.

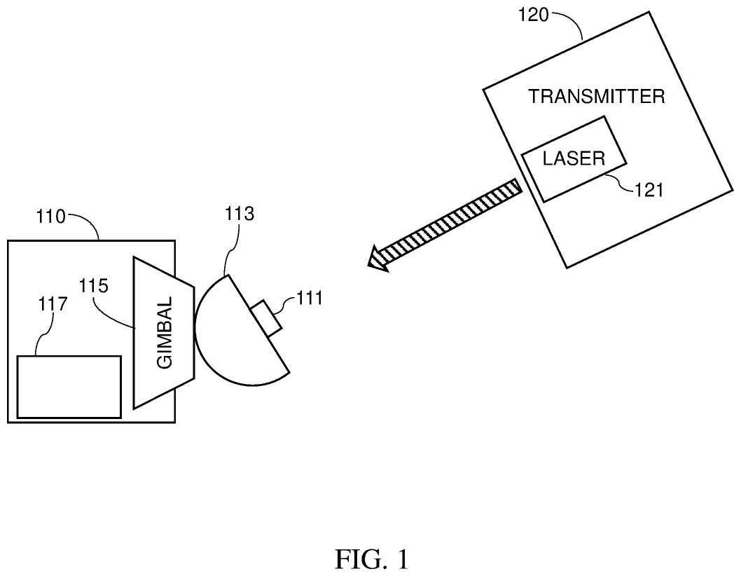

Reference is now made to FIG. 1, which shows a half-duplex subsystem for free space optical (FSO) communication according to an embodiment. A half-duplex subsystem comprises a receiver 110 and a transmitter 120. Transmitter 120 comprises a laser 121 for transmitting an optical, e.g., laser, signal and/or beam. Receiver 110 comprises a detector 111, and curved mirror 113 to focus the optical signal by reflecting the optical signal to the detector. The curved mirror 113 may be placed on a gimbal 115, which may be configured to align curved mirror 113 to transmitter 120, based, e.g., on an alignment position and/or orientation determined by automated tracking unit 117.

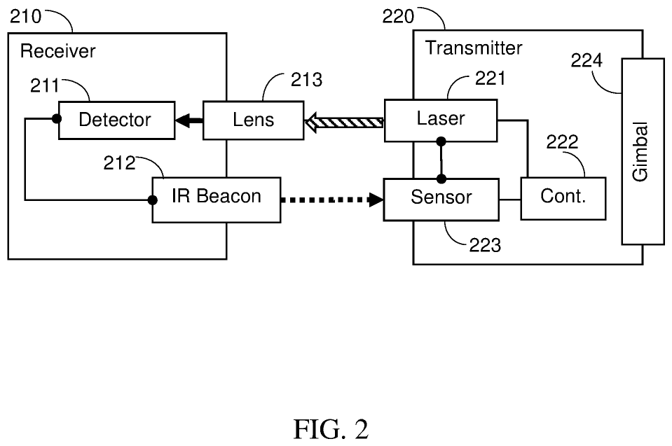

Reference is now made to FIG. 2, which shows a half-duplex subsystem for FSO communication according to an embodiment. In this embodiment, a half-duplex subsystem comprises a receiver 210 and a transmitter 220. Receiver 210 comprises a detector 211, an optional lens 213 to focus an optical beam to the detector, and an IR beacon 212 to guide the transmitter optical signal to detector 211 and lens 213. Transmitter 220 comprises a laser 221 for transmitting the optical signal, a sensor 223 for receiving the output form IR beacon 212, and a controller 222 (i.e., processor) for controlling a gimbal 224 based on IR beacon 212 signal.

Each sub-system is a half-duplex system and by combining two alternating facing sub-systems, a full-duplex system is enabled. For example, manually aligning the system in the general direction of the opposing link allows the IR beacon and small camera on each side to complete the precise alignment using the gimbal and/or a controllable mirror. Once the IR beacon was detected the gimbal/mirror may be locked towards the opposing link and a connection may be achieved.

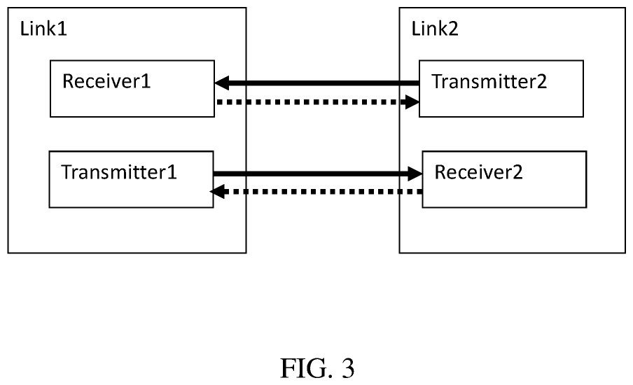

Reference is now made to FIG. 3, which shows a full-duplex system for FSO communication. By combining two of the sub-systems from FIG. 1 or 2, on opposite polarity, each communication link (Link1 and Link2) comprises a respective receiver and transmitter. For example, Link1 comprises Receiver1 and Transmitter1 and Link2 comprises Receiver2 for receiving a signal (and, e.g., sending an IR beacon) from Transmitter1 and Transmitter2 for transmitting a signal to Receiver1. Receiver1 also sends an IR beacon to Transmitter2.

In addition, the IR beacon performs other functions, such as:
When knowing the fixed distance between the receiver and the transmitter and knowing the optical IR power, the camera may provide information about the atmospheric conditions from the SNR calculation.
The IR beacon may also function as a very low rate communication line. For example, when there a problem in the detector, the IR beacon may inform the transmitter to stop the transmission.

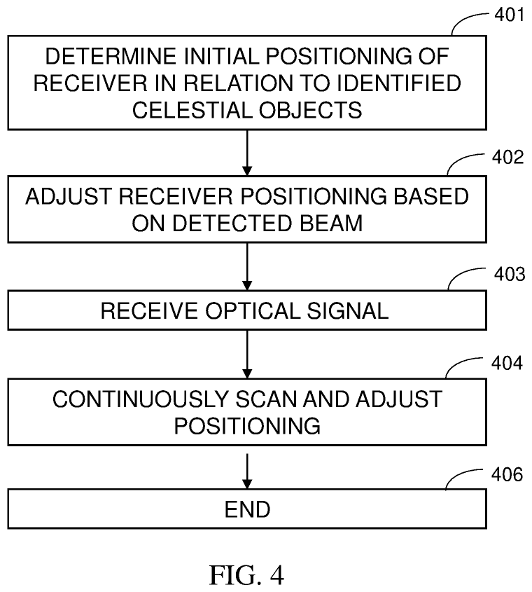

Reference is now made to FIG. 4, which shows a flowchart of a method for half-duplex FSO communication according to an embodiment. At 401, an automated tracking system may be used to determine an initial positioning and/or orientation of the receiver, based, e.g., on a location of the transmitter in relation to identified celestial objects.

At 402, the tracking system may modify a positioning of the receiver or portions thereof for optimized reception. At 403, the optical signal that is received by the detector via, e.g., the curved mirror. At 404, the automated tracking system continuously detects and locates a direction of the optical signal, and dynamically adjusts the position of the receiver for continuous optimized reception. When the transmission has completed the process ends at 406.

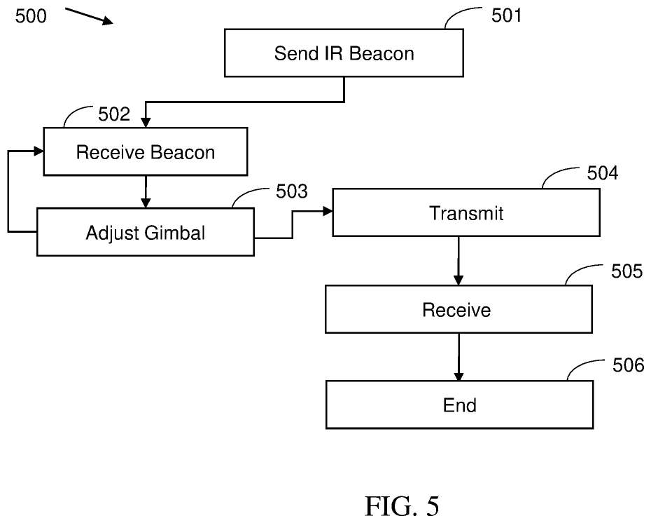

Reference is now made to FIG. 5, which shows a flowchart 500 of a method for half-duplex FSO communication according to an embodiment. A receiver sends 501 an IR beacon to the transmitter, where the beacon is received 501 and used to adjust 503 a gimbal of the transmitting laser. Since the IR beacon and the detector are aligned in a parallel configuration, and the small camera and transmitting laser are also aligned in a parallel configuration, the alignment of the IR beacon and the camera also align the laser and the detector. Once aligned, the laser transmits 504 a signal that is received 505 by the detector. When the transmission has completed the process ends 506.

An important parameter that needs to be selected carefully is the wavelength of the transmitted signal. For example, at 1550 nanometers (nm) there is an atmospheric transparency window. In addition, the wavelength may be chosen according to safety considerations and of availability of commercial off-the-shelf (COTS) components that make the system/sub-system less expensive. Other atmospheric transparency windows may include from around 300 nm (i.e. ultraviolet-B) at the short end up into the range the eye can use, roughly 400-700 nm and may continue up through the visual infrared to around 1100 nm. As the main part of the infrared window spectrum, a clear electromagnetic spectral transmission window may be between 8 micrometers (μm) and 14 μm. A fragmented part of the infrared window spectrum, such as a louvred part of the window, may also be seen in the visible to mid-wavelength infrared between 0.2 and 5.5 μm. Thus, a wavelength of the optical signal for digital communications may be between 100 nm and up to 4 μm, or at any transmission window within this range. For example, an infrared transparency window exists between 1 μm and 4 μm.

According to an embodiment, a lens diameter has an important influence on the system performance and operational range. A larger lens may collect more optical power to the detector and decrease the geometric attenuation. It is important to select the suitable lens according to the design and desired specifications. For example, a lens diameter may be of between 1 and 10 centimeters and an FOV of ˜1 degree.

When selecting the laser transmission source, it may be important to check beam divergence. A small beam divergence may reduce optical loss from the geometric attenuation. For example, a single mode long range SFP may be https://www.flexoptix.net/en/sfp-zx-plus-transceiver-100-mbit-sm-1550nm-200km-47db-ddm-dom.html?co7948=46531.

Optionally, a large optical signal transmission power may achieve an extended communication range. To achieve large optical power that may increase the operation range, it may be important to check the power conversion efficiency. Diode lasers have electrical to optical efficiency typically of the order of 50%-60%. The efficiency is usually limited by factors such as the electrical resistance, carrier leakage, scattering, absorption (particularly in doped regions), spontaneous emission, and/or the like. Another factor of the laser efficiency is the temperature—when the temperature increases the efficiency decreases.

The detector may have a high sensitivity peak at the transmitter wavelength to achieve good results. In addition, the rise time of the detector may limit the frequency that may be detected. The detector sensitivity may be dependent on the signal frequency. Another detector parameter to consider may be the dark current. It may be calculated using the following, where ID denotes the average value of the dark current:

I_{d}=(2eU_{D}BW)^{0.5}.

Although every detector may have an optimal sensitivity wavelength, the detector may also be sensitive to a relatively wide range of wavelengths (i.e., increased bandwidth at lower sensitivity). For example, a ThorLabs™ detector model APD120A is sensitive to 200 to 1000 nm wavelength. That means that when the system works at wavelength of 650 nm (the detector peak sensitivity) but when there is a background light at a wavelength between 200-1000 nm it may affect the detector, add noise, and decrease the signal to noise ratio (SNR).

To overcome this issue, a band pass filter may be attached in front of the detector's lens. The narrower the band pass the better the SNR. To demonstrate the effect of the filter on the SNR, an example filter may be a 620 nm PIXELTEQ™ band pass filter, with FWHM (full width at half maximum) of 10 nm. Placing this filter in front of the detector from demonstrates that instead of detecting light at bandwidth of 800 nm the detector is now detecting only 10 nm, with only 1.25% of the original noise (e.g., 98.75% less noise).

Another important parameter to consider may be the operational speed. There is an inherent tradeoff between the operation range and the operation speed of the system since the sensitivity of the detector may be dependent on the detector noise equivalent power (NEP) that may be inversely dependent on the frequency.

For short range, such as ≤1 kilometers (Km), communication links, a light emitting diode (LED) may be used as a transmitter, and a simple PIN photodiode or avalanche photodiode (APD) detector as the receiver. Such an FSO system may transmit information from one link to another without using a subscriber identity module (SIM) card and without loading the network. The system may operate at low speed and perhaps only in dark conditions. Nevertheless, it may be adequate for IoT applications. This method may be implemented also on aircrafts such as planes and drones.

For Mid-Range (e.g., ˜0.1-1 Km) communication links, such as those relevant for 5G communication in metro areas, a laser diode may be used as the transmitter, and a simple curved mirror with a detector may be used as the receiver. In other embodiments, a simple lens and detector may be used as the receiver, e.g., to enable the system to work at high speed, such as around 10 gigabits per second (Gbps). These systems may have the ability of increasing the internet capacitance of a structure by adding more communication links to a building, without the need of underground digging and fiber-optic cable placement. In addition, these mid-range systems may also expand the backhaul bandwidth to the city by gaining wider bandwidth communication.

For Long Range (e.g., ˜10 Km) communication links, a laser transmitter and at least one curved mirror and/or telescope with a detector may provide communication with a data rate of around 1 Gbps between isolated rural villages or aircrafts like planes and drones.

For nanosatellite communication links, an extreme long range (e.g., ≥500 Km) system may be used. Using a laser source as the transmitter and a curved mirror and/or telescope connected to the receiver as the ground station may replace the RF communications in use today. The attenuation of exit the atmosphere may be equal to the attenuation traveling 10 Km inside the atmosphere, e.g., dₐₜₘ=10 Km. Lₐₜₘ=0.2 [dB/K m] at clear weather, there for the total atmosphere attenuation of exit the atmosphere may be equal to Lₐₜₘ=0.2·dₐₜₘ=0.2·10=2 [dB].

Due to the laser small beam divergence we may approximate Dₛ=d·θ. Therefore, the geometric attenuation may be described as:

$$\frac{{P}_{r}}{{P}_{t}} = {( \frac{{D}_{r}}{{D}_{s}} )}^{2} = {( \frac{{D}_{r}}{d \cdot θ} )}^{2} .$$

From this equation one may derive that the geometric attenuation is −80 [dB]. The total link budget calculation is:

Pᵣ[dBm]=Pₜ[dBm]−L_{geo}[dB]−Lₐₜₘ[dB]

Thus Pr[dBm]=Pt[dBm]−Lgeo[dB]−Latm[dB] and Pr[dBm]=20 [dBm]−80 [dB]−2 [dB]=62 [dBm].

When a speed of 1 megahertz (MHz) is assumed, then the NEP=−66 [dBm]. This may lead to a link safety margin (or noise margin, NM) of 4 [dB]. A speed of 1 kilohertz (KHz) may give a NM of 19 [dB], thus the NEP=−81 [dBm].

The calculation that the NM is a few decibels means that a link may be possible.

In addition, the results of our laser experiment may demonstrate the feasibility of getting a laser communication link from space. The results show a detected clear signal when the detector was without a lens and the active area was only 1 millimeter (mm). With an optical power of 5 milliwatt (mW) at a distance of 1.5 Km, the detected signal Pᵣ=56.3 [dB]. The NEP at speed of 42 KHz is −73 [dBm] what gives a NM of 16.7 [dB].

Another application for long range systems using nanosatellites is communication between different cities. Sending the signal through the satellites may overcome atmospheric disruptions. Using airplanes to daisy-chain the links to the satellites is advantageous as the temperature is significantly lower than on earth, resulting in less thermal noise and better efficiency. In addition, a configuration using airplanes may also supply internet services to the airplane passengers.

Optionally, micro-electro-mechanical system (MEMS) mirrors may be used for nanosatellite FSO communication links. For example, two-dimensional (2D) MEMS mirrors may be used instead of gimbal laser aiming mechanisms. This may be used for:
An accurate aiming mechanism—such as a sub 0.1 degree aiming accuracy (i.e., may be needed for a global positioning/navigation system,
a laser (FSO) modem on the satellite capable of high speed communications, and
a ground station with curved mirrors and/or an FSO telescope.

For example, a relatively large aperture (e.g., 2-3 milliradian) and high-power lasers (e.g., up to 10 watts) may be used. The nanosatellite attitude control mechanism may be based on standard reaction wheels and an optional water thruster (such as for formation flight). For example, the last pointing stage of a satellite communication link may be done using MEMS mirrors. The use of the 2D MEMS mirror may be for fine tuning the communication link to a fixed ground station.

The use of a relatively wide FOV 2D mirror may allow a ±10 degrees scan of a satellite IR beacon by the ground station telescope. An accurate angular calibration may be performed on the satellite in real time via a 20-degree solid angle scan—similar to a laser projector scan. Using a 2D MEMS mirror on the receiver for fine tuning the FOV, such as changing from a 2-10 degrees FOV to a sub milliradian FOV, may reduce the overall noise on the receiver side.

Optionally, the disclosed FSO communication links are used for a fronthaul portion of a communication network. For example, growing cities are undergoing a natural developmental process in which more structures and offices are being built, which causes the volume of media consumption to grow. On the other hand, most of the underground infrastructure remains unchanged and this causes a burden on the communications lines. The cost of installation new underground optical fibers is very high and very complex to perform, since the area is in high use and the installation of the fibers may disrupt traffic arrangements, may use a very expensive quarrying equipment, may require long working time, etc.

Unlike the installation of underground fiber optics to transmit communication from building to building, installation of an FSO system between the roofs of the buildings may transfer the communication from the old building to a new building easily as all that is required is to set the system in a dedicated position at the top of the building and calibrate the pair of transceivers. For example, embodiments of the disclosed sub-systems may be used to communicate a large quantity of data from large distances, e.g., in a cost efficient form while keep the transmitter and receiver aligned when the positions of buildings change as a result of wind, storms, temperature, and/or the like.

Optionally, the disclosed communications links is not used as exclusive links for network communication, but as an addition and/or supplement to existing networks. For example, as an interim solution until network infrastructure is upgraded. For example, in the short periods during which the communication may not be allowed, the user may experience a reduction in the quality of service but may still be connected to the network. For example, the disclosed solution is cost effective and easy to implement.

Optionally, in very high-density urban areas the disclosed system avoids the issue of multipath interference. Multipath interference is a phenomenon that occurs when an RF wave from a source travels to a detector via two or more paths and, under the right conditions, the two (or more) components of the wave interfere and cause interruptions to the signal. Furthermore, RF communication may have a problem of harmonic disruptions due to other RF channels.

Optionally, coherent detection is used at the receivers. For example, the optical receiver may track the phase of the optical transmitter to extract any phase and frequency information carried by the transmitted signal. For example, this is in contrast to a direct detection receiver, where the detector only responds to changes in the receiving signal optical power and does not extract phase or frequency information from the optical carrier.

For example, in coherent optical systems, a narrow line width tunable laser, serves as the local oscillator (LO) to create the frequency difference between the LO and the receiver optical carrier. That difference may be designed to be small and within the bandwidth of the receiver. The LO tunes its frequency to intradyne with the received signal frequency through an optical coherent mixer, and thereby recovers both the amplitude and phase information contained in a particular optical carrier

Coherent detection may have two main advantages compared to direct detection: (i) the detector sensitivity may be greatly improved compared to direct detection, and (ii) the detector may achieve better capacity in the same bandwidth since the coherent detector may extract amplitude, frequency, and phase information from an optical carrier.

A network's service level agreement (SLA) may require that a communication link be available 99.99% of the time. Unlike working with fibers or radio frequency (RF) communications, an FSO systems may face unknown attenuation in the medium that may be close to zero and up to several hundred decibels per kilometer (dB/Km), such as during hazy weather conditions. Compliance with the network's SLA may result in the system being non-operational during worst-case scenarios. The attenuation at this case is about 400 dB/Km while at the rest of the time the attenuation may be a few fractions of dB/Km. Obeying the SLA regulation results in a significant reduction at the operation range. The FSO communication link techniques do not apply the network's SLA. It is based on a best effort method that considers only the best weather scenario on a clear day when the atmospheric attenuation is 0.2 dB/Km. Atmosphere turbulence may be neglected since the system is placed on high buildings or at open space when the turbulences are not significant. The overall scheme of the FSO system may be based on mesh logic—there may be a lot of FSO links at multiple places and the control system choses continuously the optimal available link. A poor weather at point A may steer the active links to point B that has good weather and the signal may be transferred through that point.

Experimental Results

In a research program carried out by the inventors, a small satellite was launched with an FSO communication link. The system transmitted data from the satellite using a small laser diode and the signal was received using a telescope and a detector.

The satellite data may include:
Images,
RF scans (SDR data),
Remote sensing data (sensors),
Relay data—the satellite may be relaying data between two (or more) ground and/or mobile stations (e.g., airplanes),
Relay data between satellites/ground stations,
and/or the like.

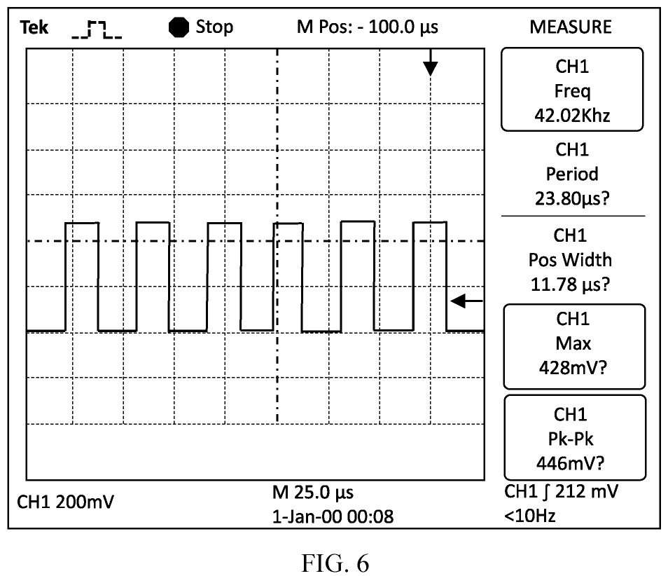

A system with a simple LED transmitter connected to a microprocessor and a detector with a lens at the receiver side was built. The microprocessor modulated the LED with a square wave to demonstrate an On-Off Keying (OOK) modulation. Reference is now made to FIG. 6, which shows a graph of experimental results of FSO communication. The graph shows that the square wave is received correctly at the detector. The ratio between the LED wavelength and the detector peak sensitivity wavelength was adjusted. Once the LED transmitted at the exact wavelength of the detector peak sensitivity, the results improved significantly. The LED used transmitted at an 870 nm wavelength with a forward optical power of 8.2 milliwatt (mW) and a beam divergence of 20 degrees. Clear results were obtained at 12.2 meters distance between transmitter and receiver. This experiment demonstrated the concept of FSO communication links for IoT applications.

In another experiment, an LED signal was transmitted from a distance of 4 kilometers (Km). The signal was detected using a video camera at a frequency of 50 Hz due to the limitations of the video camera. This experiment demonstrates applications in aircrafts, such as drones or balloons, where the data is transmitted or received at low bandwidth from a distance of several kilometers.

Another experiment tested the ability of an optical link at a distance of 1.5 Km. The transmitter was a laser diode with max optical power of 5 mW. The laser transmission was modulated at a frequency of 42 kHz. The transmitter system aligned with a telescope to the receiver system. The receiver system may include a detector connected to a 45-millimeter diameter plano-convex lens and the electrical signal was collected on a digital oscilloscope. The oscilloscope demonstrated a clear stable signal at a range of 1.5 Km.

In another experiment, the accurate tuning of a small laser transmitter on a gimbal was tested. The experimental results showed that the laser was directed at range of 20 meters, using the gimbal, to a square equal to one milliradian of the laser beam divergence. The gimbal system made a closed loop monitoring and save the gimbal position using a microprocessor and a camera.

By reducing the accuracy and the bit rates requirements, a communication technique may achieve a much larger operation range. Moreover, this communication technique may be implemented in multiple scenarios. In addition, the communication technique may be used in an FSO system that is both adjustable and affordable, such as cost effective, easy to install, easy to uninstall, and/or the like.

The present system implements this idea and separates two components. The receiver system is fixed to a stable surface and includes a detector, curved mirrors, a gimbal and a star tracker. In other embodiments, the receiver system is fixed to a stable surface and includes a detector, a lens and a small light source, such as a LED or laser that transmits a beacon. The transmitter system includes of a small and lightweight laser calibrated to a small camera or simple CCD that may be connected to a gimbal. The camera detects the beacon, and by using a navigation algorithm, the gimbal points direct to the detector in a closed control loop. In other embodiments, the transmitter system may not include the gimbal, and the alignment may be ensured using the star tracker.

The increased development of the Internet-of-Things (IOT) may need multiple SIMs for each user. The estimation is that in couple of years every person may hold about 10 SIMs total, each for another need. This new reality overloads the network. There is a need of solution to provide communication for all of these IoT products without consuming too much bandwidth. FSO Communication may overcome this problem. Using wide direction antennas to transmit the data and a simple receiver to detect the signal easily due to the wide beam divergence. This may ease the alignment of the communication link. The optical link does not use the radio frequency spectrum, and thus may not overload the network and waste bandwidth.

The middle range scenario is relevant for 5G communication in metro areas. The access network bottleneck may increase the demand for more communication bandwidth and increase the needed backhaul portion of the network. FSO systems may have the ability of increasing the internet capacitance by adding more lines into a building without the need of underground digging for fibers placement. These systems may expand the backhaul portion of the network.

Optical communication may have significantly wider bandwidth than RF communication, e.g., enabling a high data rate. There may not always be a pathway signal, so the communication network is not available all the time. For that reason, the communication bandwidth plays an important role. For example, during the time (such as an hour, a minute or even a second, depends on the application) that a link is established, the amount of data that may be transferred may be large in comparison to RF communications.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that the present application controls.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A digital communication system comprising:
an optical receiver comprising a curved mirror and an optical detector associated with said curved mirror, wherein said optical receiver is configured to recieve a laser optical signal from an optical transmitter;
and
an automated tracking system configured to:
(i) determine a desired orientation of said optical receiver in relation to said optical transmitter,
(ii) move said optical receiver to said orientation, and
(iii) continuously adjust said orientation to maximize a measured strength of said received optical signal.

2. The digital communication system of claim 1, wherein said determining is based, at least in part on one of: detecting a celestial location of said optical transmitter, and performing a scan by said optical receiver to detect a signal of the said optical transmitter.

3. The digital communication system of claim 2, wherein said detecting is based, at least in part, on a known position of said optical transmitter in relation to one or more identified celestial objects.

4. (canceled)

5. The digital communication system of claim 1, wherein said curved mirror is a concave mirror configured to reflect at least some of said optical signal from a surface of said concave mirror to a focal point of said concave mirror.

6. The digital communication system of claim 1, wherein said detector is located at one of: a focal point of said curved mirror and a center of curvature of said curved mirror.

7. (canceled)

8. The digital communication system of claim 1, wherein the optical transmitter is configured to transmit an optical signal of a specific wavelength, wherein the optical receiver is configured to receive the optical signal, and wherein the specific wavelength is one of between 100 nanometers (nm) and 4 micrometers (μm), between 100 nm and 2700 nm, and between 1 μm and 4 μm.

9. (canceled)

10. (canceled)

11. (canceled)

12. A method for free space optical communication, comprising:
operating at least one hardware processor for:
determining a desired orientation of an optical receiver in relation to an optical transmitter, wherein said optical receiver comprises a curved mirror and an optical detector associated with said curved mirror,
moving said optical receiver to said orientation, and
adjusting continuously said orientation to maximize a measured strength of said received optical signal.

13. The method of claim 12, wherein said determining is based, at least in part on one of: detecting a celestial location of said optical transmitter, and performing a scan by said optical receiver to detect a signal of the said optical transmitter.

14. The method of claim 13, wherein said detecting is based, at least in part, on a known position of said optical transmitter in relation to one or more identified celestial objects.

15. (canceled)

16. The method of claim 12, wherein said curved mirror is a concave mirror configured to reflect at least some of said optical signal from a surface of said concave mirror to a focal point of said concave mirror.

17. method of claim 12, wherein said detector is located at one of: a focal point of said curved mirror and a center of curvature of said curved mirror.

18. (canceled)

19. The method of claim 12, wherein the optical transmitter is configured to transmit an optical signal of a specific wavelength, wherein the optical receiver is configured to receive the optical signal, and wherein the specific wavelength is one of: between 100 nanometers (nm) and 4 micrometers (μm), between 100 nm and 2700 nm, and between 1 μm and 4μm.

20. (canceled)

21. (canceled)

22. (canceled)

23. A digital communication system comprising:
an optical transmitter;
an optical receiver comprising (i) a detector configured to receive an optical signal, and (ii) an infrared (IR) beacon configured to emit an IR signal towards the optical transmitter, wherein optical axes of the detector and the IR beacon are substantially parallel,
wherein the optical transmitter comprises:
a. a laser configured to transmit the optical signal matched in frequency to the detector,
b. a sensor configured to receive an IR beacon signal from the IR beacon,
c. a controller configured to receive an output from the sensor, and
d. an electromechanical pointing device electrically connected to the controller, wherein the controller is further configured to adjust an orientation of the electromechanical pointing device based on the output from the sensor.

24. The digital communication system of claim 23, wherein the electromechanical pointing device comprises a two-axis gimbal.

25. The digital communication system of claim 23, wherein the electromechanical pointing device comprises at least one micro-electro-mechanical system (MEMS) mirror.

26. The digital communication system of claim 23, wherein the optical transmitter is configured to transmit an optical signal of a specific wavelength and wherein the optical receiver is configured to receive the optical signal.

27. The digital communication system of claim 26, wherein the specific wavelength is between 100 nanometers (nm) and 14 micrometers (μm).

28. The digital communication system of claim 26, wherein the specific wavelength is between 100 nm and 2700 nm.

29. The digital communication system of claim 26, wherein the specific wavelength is between 1 μm and 4 μm.

30. (canceled)

31. (canceled)

32. (canceled)
